(19) United States
(12) Patent Application Publication
(10) Pub. No.: US 2012/0303333 A1
(43) Pub. Date: Nov. 29, 2012

(54) SYSTEM AND METHOD FOR NON-DESTRUCTIVE TESTING

(75) Inventors: Ingo Stuke, Reinfeld (DE); Michael Wuestenbecker, Lutiensee (DE); Andreas Beyer, Hamburg (DE); Holger Lux, Bargteheide (DE); Lothar Horn, Ahrensburg (DE)

(73) Assignee: General Electric Company, Schenectady, NY (US)

(21) Appl. No.: 13/116,946

(22) Filed: May 26, 2011

(51) Int. Cl. G06F 17/50

(52) U.S. Cl. 703/1

(57) ABSTRACT

Non-destructive testing and examination systems and methods generate models and other representations of a part. These models can be used to perform analysis such as defect detection and categorization. The present disclosure identifies, in one embodiment, a method and system that identifies particular locations on the part for analysis. These locations correspond to regions of a reference model, which may comprise a representation of the part that a computer aided design (CAD) package can generate. The method provides for test parameters to be assigned or associated with the region so as to direct and instruct the execution of the relevant part analysis protocols. In one example, the test parameters identify criteria for one or more types of defects that may be found on the part.

### BACKGROUND OF THE INVENTION

The subject matter disclosed herein relates to non-destructive testing and, more particularly, to systems and methods useful for defect detection in manufacturing environments.

Non-destructive testing can be done by testing systems that may deploy equipment to inspect the interior of parts. This equipment includes computed-tomography (CT) scanners, ultrasonic scanners, X-ray scanners, and magnetic resonance inspection (MRI) scanners. Other testing systems may deploy coordinate measuring machines that use contact and non-contact probes (e.g., laser probes) to measure the exterior surfaces of the part. Many of these pieces of equipment generate three-dimensional models of the part. These models are representations of the part and permit visual inspection and analysis of the part without the need to disrupt the structural integrity of the part-under-inspection.

Many testing systems require that an end user identify regions of the part model for analysis. The end user often finds these regions on a manufacturing drawing, which details the dimensions and other aspects of the part geometry that are used to construct the part. In addition to the dimensions, the part designer may, for example, designate locations on the parts at which defects may occur.

For manufacturing environments that produce parts in large numbers and that may produce a wide variety of different parts, quality review processes that incorporate non-destructive testing is important. However, such environments often must meet critical time and quantity deadlines that permit very little margin for error and delay. Thus, while accuracy of quality review is necessary to success, streamlining the various production processes, including the quality review process, is necessary to improve throughput, lower costs, as well as to maintain customer satisfaction.

The discussion above is merely provided for general background information and is not intended to be used as an aid in determining the scope of the claimed subject matter.

### BRIEF DESCRIPTION OF THE INVENTION

The present disclosure highlights improvements in manufacturing environments, focusing in certain embodiments on systems and methods for non-destructive testing. Exemplary embodiments reduce the need for end user intervention by permitting the use of three-dimensional models that the part designer creates. The systems and methods can integrate information that these models provide to facilitate analysis of parts and may, ultimately, improve accuracy and throughput of the manufacturing environment in which embodiments of the systems and methods below are applied.

In one embodiment, a non-destructive testing system comprises a scanning device configured to generate a part model and a control unit coupled to the scanning device. The control unit is operatively configured to execute a part analysis that compares areas of the part model with regions of a reference model of the part to identify whether feature of interest are present in the part. The part analysis uses test parameters, which are assigned to the regions and which are indicative of the feature of interest. In one example, the reference model comprises a computer-aided design (CAD) representation of the part.

In another embodiment, a method implemented on a non-destructive testing system comprises a step for generating a reference model of a part, the reference model comprising a region at which a feature of interest may be found on the part. The method also comprises steps for assigning a test parameter to the region, receiving a part model of the part, and locating a portion of the part model that corresponds to the region. The method further comprises a step for utilizing the test parameter to identify whether the feature of interest is present in the portion of the part model.

In yet another embodiment, a method for non-destructive testing comprises providing a design model comprising a region that corresponds to a location on a first part at which a feature of interest can be found. The method also comprises aligning the design model with a reference model of the first part and converting the region to a volume unit. The method further comprise assigning test parameters to the volume unit, receiving a part model of the first part, and executing a part analysis that compares areas of the part model that correspond to the volume unit with the test parameters to identify whether the feature of interest are present in the first part. In one example, the reference model and the part model comprise three-dimensional representations of the first part.

This brief description of the invention is intended only to provide a brief overview of subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of invention. In the drawings, like numerals are used to indicate like parts throughout the various views. Thus, for further understanding of the invention, reference can be made to the following detailed description, read in connection with the drawings in which:

FIG. 1 depicts an example of part that may be subject to non-destructive testing;

FIG. 2 depicts an example of a reference model of a part such as the part of FIG. 1; and

FIG. 3 depicts an analysis model that is useful to locate defects in a part such as the part of FIG. 1;

FIG. 4 depicts a flow diagram of an exemplary embodiment of a method for locating defects in a part model;

FIG. 5 depicts a flow diagram of another exemplary embodiment of a method for locating defects in a part model;

FIG. 6 depicts an exemplary embodiment of a non-destructive testing system that can implement the methods of FIGS. 4 and 5; and

FIG. 7 depicts an exemplary embodiment of an automated inspection system that comprises a non-destructive testing system such as the non-destructive testing system of FIG. 6.

### DETAILED DESCRIPTION OF THE INVENTION

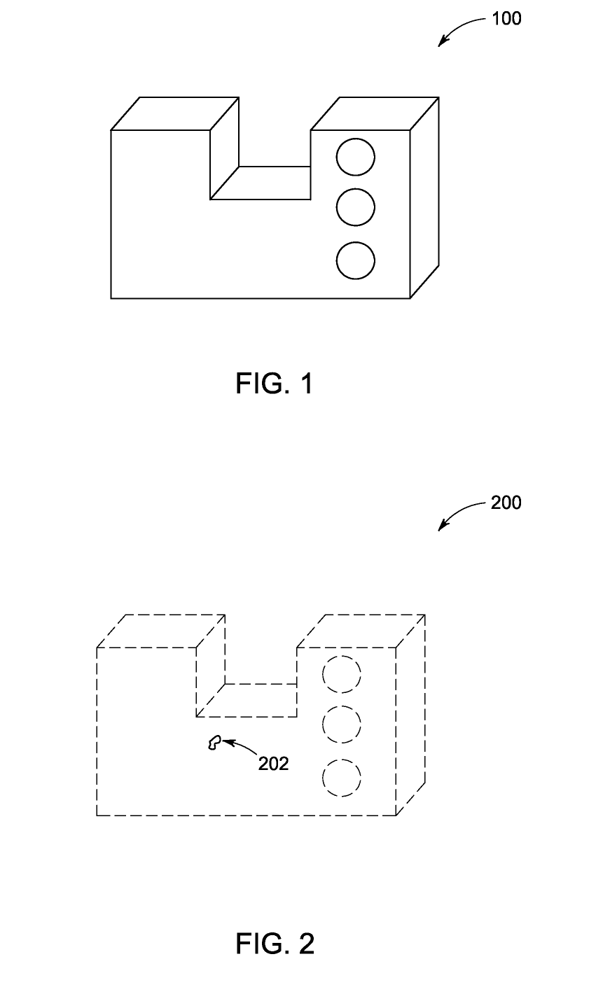

FIG. 1 depicts an example of a part-under-inspection 100 (also “a part 100”) that can result from a variety of manufacturing processes (e.g., casting, molding, forging, welding, forming, machining, etc). The part 100 may be subject to non-destructive testing techniques that may utilize various imaging technologies including computed-tomography (CT) scanners, X-ray imagers, magnetic resonance imagers (“MRI”), ultrasonic scanners, and the like. Such technology can generate a part model of the part 100 that shows the interior of the part 100 normally hidden from view. This feature permits an end user to perform certain inspection and analysis tasks without the need to sacrifice the structural integrity of the part 100.

FIG. 2 illustrates an example of a part model 200, which may represent the part of FIG. 1 and can result from non-destructive testing identified above. The part model 200 comprises a feature of interest 202 such as a defect or other anomaly that occurs as a result of the manufacturing process or through implementation and use. Defects can be internal and external. Examples of defects include material defects, e.g., occlusions and porosity, and manufacturing defects that the manufacturing process and/or the application in which the part is implemented may cause. Manufacturing defects include fracture, creep, and corrosion, all of which may be hidden from view and may cause or generate failures in the part. Moreover, while the discussion below may focus on defects internal to the part, the systems and methods below are likewise applicable to those defects that appear on the surface of the part 100.

The present disclosure describes below various systems and methods that analyze the part model 200 to identify the presence and/or absence of the feature of interest 202. To speed up processing time and other facets of the analysis, a reference model is utilized to focus the analysis at locations of the part model 200 where the features of interest 202 are likely to be found. In one embodiment, the reference model (also “a design model”) comprises a representation of the part, which an end user can generate on a computer-aided design (CAD) package. Output (e.g., the models) that the imaging technology generates can likewise act as the reference model, as applicable to one or more examples below.

The reference model may include regions where defects and other anomalies are likely to be found on the part. In one example, configurations permit the end user to designate these regions such as during the design stage and/or at the outset of an inspection procedure. In other examples, the system can automatedly designate the regions as part of, e.g., executable instructions that the system implements to perform the inspection procedure.

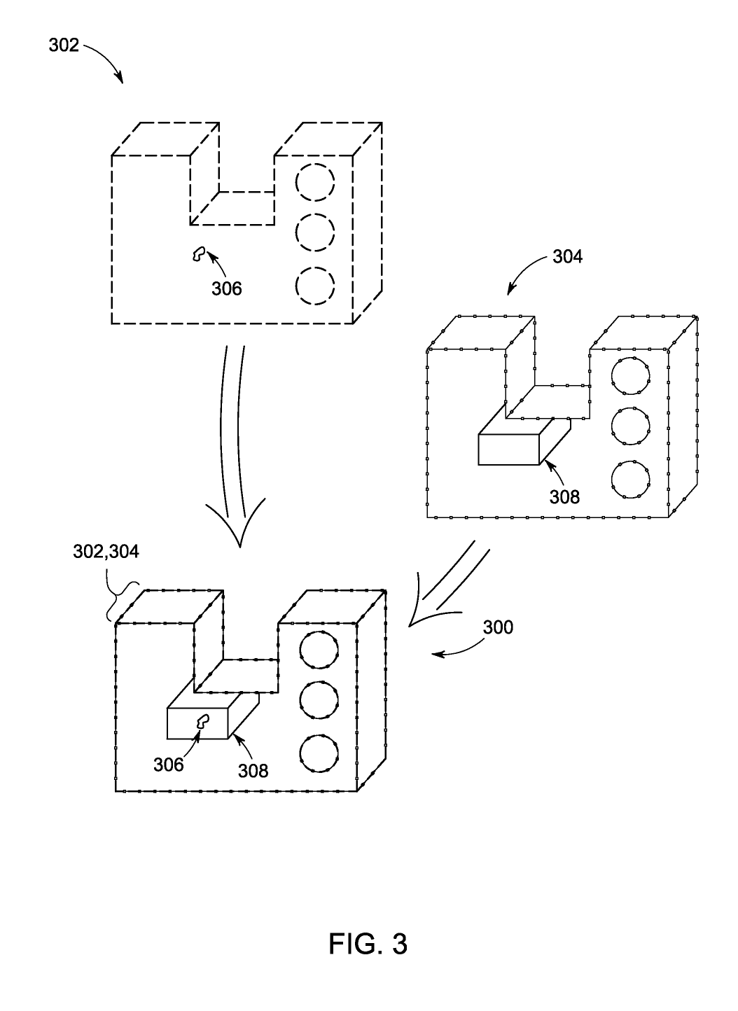

FIG. 3 provides a useful illustration to describe analysis of a part (e.g., the part 100) using the part model and the reference model. FIG. 3 depicts an analysis model 300, which is the subject of analysis to determine whether features such as the features of interest are present in the part model. The analysis model 300 incorporates a part model 302 and a reference model 304. In the present example, the part model 302 has a feature of interest 306 and the reference model 304 has a region 308. The region 308 takes the form of a volume unit 310, which surrounds the feature of interest 306.

To construct the analysis model 300, the part model 302 is aligned with the reference model 304. This step positions the region 308 proximate a location on the part model 302 where the feature of interest 306 may be found. In one embodiment, the inventors propose to analyze only those portions of the analysis model 300 that are found inside of the volume unit 310. Portions of the analysis model 300 that are not found in the region 308 may be wholly ignored.

The analysis model can comprise the combination of multiple models, as FIG. 3 illustrates and the present disclosure describes above. In other example, the analysis model may comprise only the reference model in combination with, or separate from, other model the inventors contemplate herein. That is, combination of the reference model with, e.g., the part model, may not be required when, for example, information useful for part analysis is assigned to or associated with the reference model.

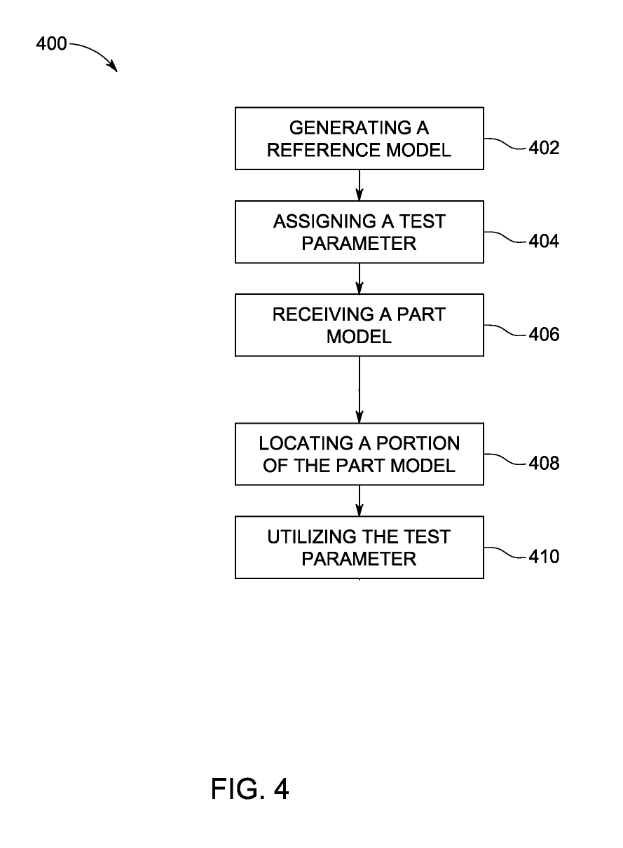

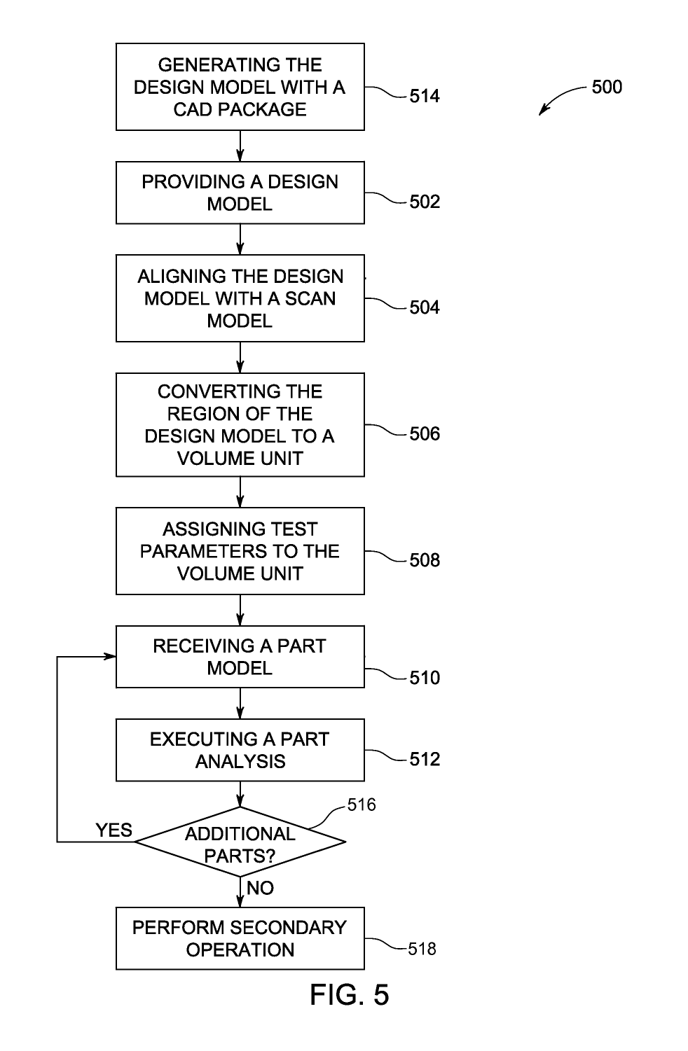

FIGS. 4 and 5 illustrate flow diagrams of exemplary embodiments of a method 400 (FIG. 4) and a method 500 (FIG. 5) that are useful for analyzing a part model as part of a non-destructive testing protocol. Embodiments of these methods may take the form of executable instructions that cause certain elements (e.g., a CT scanner) of a testing system to operate. These instructions can reside on certain machine readable medium and/or computer program products such as, but not limited to, an electronic, magnetic, optical, electromagnetic, infrared, or semiconductor system, apparatus, or device, or any suitable combination thereof.

In FIG. 4, the exemplary method 400 includes, at block 402, generating a reference model and, at block 404, assigning a test parameter to a region of the reference model. The method 400 also includes, at block 406, receiving a part model, at block 408, locating a portion of the part model, and, at block 410, utilizing the test parameter to identify whether a feature of interest is present.

As the disclosure mentions above, the reference model can incorporate the regions for analysis. These regions may reside proximate features of the part such as fillets, holes, bores, thin walls, and the like. Generally these areas may be prone to various defects and, thus, the regions can identify the extent to which these defects may form relative to the feature. The inventors note that methods of the present disclosure afford the end user opportunity to designate the regions within the reference model. For example, the end user may view the reference model via a graphical user interface (“GUI”) or other interactive tool. The GUI may provide various toolbars, icons, and other selectable implements that facilitate the selection and integration of the region into the model. Moreover, while the user may identify only portions of the reference model, these methods can also permit designation of the entire reference model as desired.

The test parameters may include, for example, certain numeric values that define and/or describe characteristics of features. Various algorithms (e.g., a defect detection algorithm) may utilize these values during data and image processing that occurs as part of the analysis of the part model. Those artisans having skill in the relevant analytical arts will understand the nature and operation of these algorithms, as well as the scope of the test parameters that the present disclosure contemplates herein. In one embodiment, the test parameters may include certain classifications and rules from which the method 400 can identify the feature of interest and, in one example, the type of defect present in the part model.

Designation of the region in the reference model can likewise include assignment of the test parameters thereto. For example, the end user may locate a region in the reference model that is proximate a feature (e.g., a fillet) where defects are likely to occur. The reference model may be of sufficient size, shape, and configuration to include a portion of the part around the feature. Moreover, the end user may assign to that region test parameters that are useful to identify the defect (e.g., a stress crack that cooling of a mold induces) that is most commonly found at the feature. The test parameters may be general, i.e., identifying criteria that only look for a defect, or specific, i.e., identifying criteria that look for a defect having specific dimensions (e.g., length, width, depth, etc.).

The method 400 can also includes steps for aligning or registration of the part model and the reference model, which promotes proper positioning of the regions on the part model. As shown in FIG. 3 above, when the part model (e.g., the part model 302) and the reference model (e.g., the reference model 304) are superimposed, the region (e.g., the region 308) should locate relative to the feature (e.g. the feature 306) of the part to which the regions are assigned. Alignment can utilize certain aspects of the part model and the reference model, such as coordinate systems and other geometry that may provide a common reference between the part model and the reference model. In one example, the method 400 may afford the end user the ability to align the part model and the reference model, e.g., by dragging one of the models relative to the other in the GUI and/or by selecting certain common reference points in each of the models in the GUI.

In addition to detection of the feature of interest, the method 400 can incorporate certain secondary operations for further analysis of the part. Secondary operations include a step for comparing the dimensions of the part model and the reference model. Other operations may afford additional analytical tools such as physical properties (e.g., mass, volume, etc.) and material properties (e.g., composition). The different tools may be selected in accordance with the type of scanning device and/or testing system on which the method 400 is deployed. For example, in addition to a CT scanner, the testing system may include a mass spectrometer or other device that can identify the material composition of the part.

The exemplary method 500 of FIG. 5 includes, at block 502, providing a design model of a part and, at block 504, aligning the design model with a scan model.

The method 500 also comprises, at block 506, converting a region of the design model into a volume unit, at block 508, assigning test parameters to the volume unit, and, at block 510, receiving a part model of the part. The method 500 further comprises, at block 512, executing a part analysis protocol, which may compare areas of the part model that correspond to the volume unit with the test parameters to identify whether features of interest are present. The method 500 may also comprise, at block 514, generating the design model in a computer-aided design (CAD) package and, at block 516, determining whether additional parts are to be analyzed. If so, then the method 500 continues to block 510 to receive another part model. If no other parts are to be analyzed, then the method 500 may include, at block 518, performing a secondary operation, which may include a step to identify dimensional differences and other abnormalities, e.g., as between the part model and the reference model. Likewise, in another embodiment, the method 500 may continue with the secondary operations before receiving the part model for the next part.

A part designer may generate the design model as part of the design process. This model may originate from a CAD package (e.g., Pro-Engineer® and AutoCad®). The design model and the part model may likewise be generated by scanning a sample of the part such a part from a production run. CAD packages may include executable instructions (e.g., software) that allow selection of the regions where analysis is to occur and, in some examples, the package can permit assignment of the test parameters to those regions. In one example, the executable instructions that instruct the method 500 may provide sufficient tools for the part designer and/or other end user to generate the design model, as well as to identify the regions and test parameters. In another example, the design model exports from the CAD package so as to permit the end user to interface with the model such as to identify the regions and the test parameters.

The scan model may comprise a representation of the part that the scanning device generates. The scan model can, in one example, form the basis for the analysis of each part that is found on, e.g., a production line. For example, an end user may initiate a scan of a part before initiating the remaining steps of the method 500 (and/or analysis and inspection of the parts that make up the specific production run or lot for use in quality review selection). The method 500 can then match the resulting scan model with the design model, form the volume units, and assign the test parameters.

Embodiments of methods (e.g., the method 400 and the method 500) can operate on models (e.g., the design model, the scan model, and the part model) that are solid models or, in other words, provide features of the part in three-dimensions. CAD packages are known for this purpose. Scanning devices such as CT scanners are likewise understood to generate models with height, width, and depth. In one embodiment, the method 500 can accommodate for design models that have only two dimensions. These two-dimensional models may be common when utilizing representations of the part that are associated with manufacturing prints and drawings. While computer programs permit exchange of these representations, the models themselves may lack a dimension (e.g., depth) commonly found in three-dimensional representations of the part. In any case, an embodiment of the method 500 can identify the region(s) of the two-dimensional design model and generate a volume unit from the region. This feature may require executable instructions to generate the three-dimensional volume unit from a two-dimensional region. For example, the region associated with a two-dimension model might be square and the volume unit might be cubic. The volume unit permits analysis of the part (and part model) to identify other characteristics associated with the feature of interest.

Embodiments of the method 500 (and the method 400) may suit implementation in various production environments. For example, high-volume and mass production processes such as casting and molding often produce large quantities of the same or similar parts. In one embodiment, implementation of these methods may require that the method continue to operate to evaluate consecutive parts. As the discussion provides below, examples of such environments may incorporate a scanning device (e.g., a CT scanner) into an automatedly arranged production line.

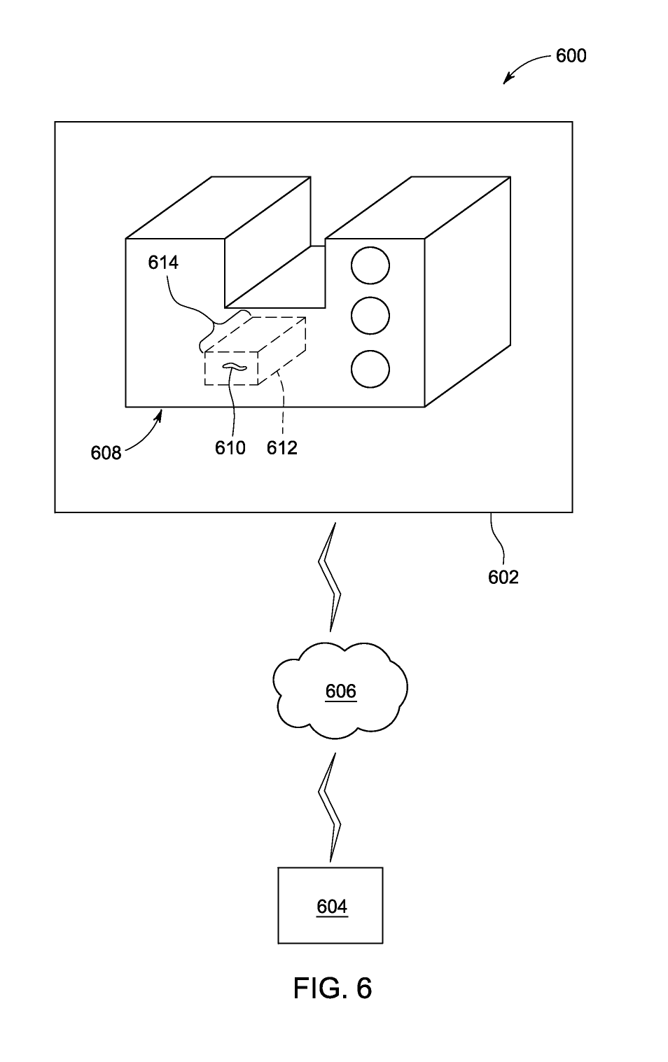

FIG. 6 illustrates an exemplary embodiment of a testing system 600 that can be used for non-destructive testing and inspection in various manufacturing environments (e.g., casting, molding, welding, etc.) Embodiments of the testing system 600 can comprise a scanning device 602 such as a computed tomography (CT) scanner, a data storage device 604, and a network 606, which communicatively couples the scanning device 602 and the data storage device 604. In one embodiment, the scanning device 602 can generate a model 608 that is representative of, e.g., the part of FIG. 1. The model 608 comprises a feature of interest 610 such as one or more of the defects the disclosure contemplates herein. The model 608 also comprises a region 612 with a geometry 614 that may encompass at least a portion of the feature of interest 610. In the present example, the geometry is that of a rectangular volume, however, the geometry can take a variety of configurations.

The testing system 600 can communicate or transfer the data across the network 606. Communication may be wired, wireless, or by other means known in the art. The inventors likewise contemplate that cloud and cloud-based computing may provide adequate data transfer, storage, and retrieval options for implementation in connection with the testing system 600. In one example, data transfer may entail download and upload functions that facilitate movement of data between the scanning device 602 and remotely-located servers and/or databases that constitute the data storage device 604. By focusing analysis on specific regions of the part model as discussed above, the testing system 600 may improve processing time and, thus, increase throughput when the testing system 600 is deployed in high-volume production applications.

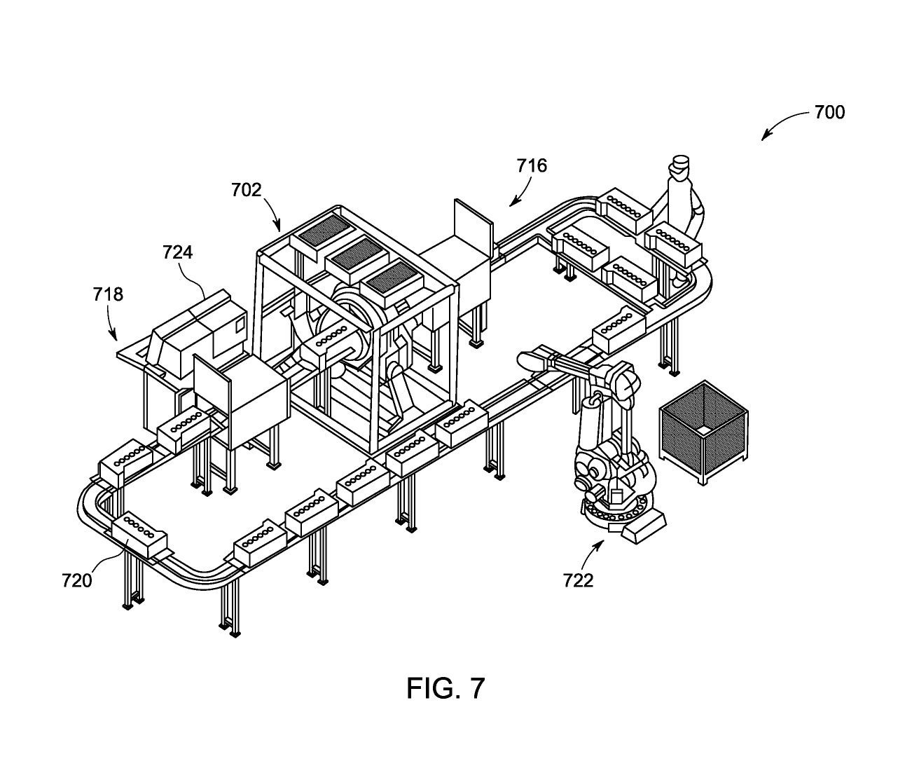

FIG. 7 provides details of an example of such a production application that deploys another exemplary embodiment of an automated inspection system 700. While like numerals are used to identify like elements as between the testing system 600 (FIG. 6) and the inspection system 700 (FIG. 7), some elements have been removed for clarity and to focus the discussion that follows below. The inspection system 700 comprises a scanning device 702. However, the data storage device and the network are not shown, but are applicable to the inspection system 700 in the manner in which this disclosure describes them above.

The inspection system 700 also comprises a conveyance device 716 and a control unit 718, which controls one or more of the scanning device 702 and the conveyance device 716. Located on the conveyance device 716 are various parts-under-inspection 720 such as molded or cast parts that manufacturing facilities may produce en mass. The inspection system 700 also comprises a robotic manipulator 722 and one or more workstations 724, such as computer monitors and displays.

The conveyance device 716 can comprise a conveyor system or other configuration of components that can translate the parts-under-inspection 720 into and through the scanning device 702. These systems may integrate with existing manufacturing infrastructure found as part of a production or fabrication line. This configuration permits the continued or substantially continuous generation of data in the form of, e.g., scan volumes, that are useful for quality review.

The control unit 718 may comprise various computing devices such as micro-controllers, data and micro processors, and the like. These devices can provide signals to the scanning device 702, the conveyance device 716, and the robotic manipulator 722. These signals may coordinate operation and, in one example, permit gathering of data from the scan volume. While the control unit 718 can provide analysis tools (e.g., software and hardware), the workstations 724 may likewise equip the inspection system 700 with relevant operation capacity to monitor and analyze the data and information that the scanning device 702 provides. In one embodiment, the workstations 724 can include displays such as LCD displays that permit the end user to interact with the testing system as well as the data that the testing system gathers.

In view of the foregoing, the inventors propose configurations and methodologies that can improve throughput for testing systems that deploy, e.g., a CT scanner. The methods can identify features of interest in parts, such as defects that would not necessarily be identified by visual inspection techniques.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A testing system for analyzing a part, said testing system comprising:
a scanning device configured to generate a part model; and
a control unit connectable to the scanning device, the control unit operatively configured to execute a part analysis that compares areas of the part model with regions of a reference model of the part to identify whether features of interest are present in the part,
wherein the part analysis uses test parameters that are assigned to the regions and which are indicative of the features of interest, and
wherein the reference model comprises a computer-aided design (CAD) representation of the part.

2. The testing system of claim 1, wherein the test parameters are assigned to the computer-aided design (CAD) representation.

3. The testing system of claim 1, wherein the control unit is integrated into the scanning device.

4. A method implemented on a non-destructive testing system, said method comprising the steps of:
generating a reference model of a part, the reference model comprising a region at which a feature of interest may be found on the part;
assigning a test parameter to the region;
receiving a part model of the part;
locating a portion of the part model that corresponds to the region; and
utilizing the test parameter to identify whether the feature of interest is present in the portion of the part model.

5. The method of claim 4, further comprising the step of aligning the part model with the reference model.

6. The method of claim 4, further comprising the step of assigning the region to the reference model.

7. The method of claim 6, wherein the reference model comprises a computer-aided design (CAD) representation of the part.

8. The method of claim 6, wherein the region identifies a volume unit of the part model.

9. The method of claim 4, wherein the reference model is imported from a computer-aided design (CAD) package.

10. The method of claim 4, wherein the test parameter identifies a defect in the part.

11. The method of claim 4, further comprising the step of comparing dimensions of the part model and the reference model.

12. The method of claim 4, further comprising the step of scanning the part with a scanning device to generate the reference model.

13. The method of claim 12, wherein the scanning device comprises a computed tomography (CT) scanner.

14. A method for non-destructive testing, said method comprising the steps of:
generating a design model comprising a region that corresponds to a location on a first part at which a feature of interest can be found;
aligning the design model with a scan model of the first part;
converting the region to a volume unit;
assigning a test parameter to the volume unit;
receiving a first part model of the first part; and
executing a part analysis that compares areas of the first part model that correspond to the volume unit with the test parameter to identify whether the feature of interest is present in the first part,
wherein the scan model and the first part model comprise three-dimensional representations of the first part.

15. The method of claim 14, wherein the design model comprises a computer-aided design (CAD) representation of the first part.

16. The method of claim 14, further comprising the step of receiving a second part model for a second part, wherein the design model and the scan model correspond to each of the first part and the second part.

17. The method of claim 16, further comprising the step of scanning the first part on a scanning device that is part of an automated inspection system.

18. The method of claim 17, wherein the scanning device comprises a computed tomography (CT) scanner.

19. The method of claim 14, further comprising the step of selecting the region with a user interface.

20. The method of claim 14, wherein the part analysis comprises a defect detection algorithm that implements the test parameter to identify the feature of interest.
